(19) United States
(12) Patent Application Publication
(10) Pub. No.: US 2025/0074624 A1
(43) Pub. Date: Mar. 6, 2025

(54) AIRCRAFT ASSEMBLY SYSTEM

(71) Applicants: Hyundai Motor Company, Seoul (KR); Kia Corporation, Seoul (KR); Hyundai WIA Corporation, Changwon-Si (KR)

(72) Inventors: Dong Ho Lee, Suwon-Si (KR); Myung Kyun Jeong, Hwaseong-Si (KR); Chang Hoon Lee, Jeju-Si (KR); Tae Hwan Kwak, Yongin-Si (KR); Sang Bin Han, Hwaseong-Si (KR); Suk Hyun Yoon, Changwon-Si (KR); Tae Jin Song, Uiwang-Si (KR); Jun Young Choi, Gimhae-Si (KR); Cheol Bae Park, Changwon-Si (KR)

(21) Appl. No.: 18/425,620

(22) Filed: Jan. 29, 2024

(30) Foreign Application Priority Data
Sep. 4, 2023 (KR) 10-2023-0117262

(51) Int. Cl. B64F 5/10; F16B 2/16

(52) U.S. Cl. CPC B64F 5/10; F16B 2/16

(57) ABSTRACT

An aircraft assembly system includes a jig; and a position adjuster connected to the jig and configured to adjust a position of the jig, wherein the jig includes a ball stud between the jig and the position adjuster, and the position adjuster includes a socket in which at least a portion of the ball stud is accommodated and in which the ball stud is rotatably fastened.

### CROSS-REFERENCE TO RELATED APPLICATION(S)

This application claims benefit of priority to Korean Patent Application No. 10-2023-0117262 filed on Sep. 4, 2023 in the Korean Intellectual Property Office, the disclosure of which is incorporated herein by reference in its entirety.

### 1. FIELD

The present disclosure relates to an aircraft assembly system for assembling a wing and a fuselage of an aircraft, and more specifically, to an aircraft assembly system in which a ball clamping unit is provided in a position adjuster for adjusting an assembly position of the wing relative to the fuselage.

### 2. BACKGROUND

Aircraft may be manufactured by a combination of a plurality of assemblies assembled together. Assembly of the aircraft can begin with assembling detailed components to prepare units of the aircraft. The units of the aircraft are largely formed as a fuselage and wings, which can be arranged and assembled adjacent to each other.

For stability of the aircraft, the wings need to be accurately assembled in an assembly position of the fuselage. However, because the fuselage and wings have a very large size and a heavy weight, accurately aligning and assembling the wings in the assembly position of the fuselage may be a complex and difficult process.

When assembling the wings and the fuselage, the wings may be coupled to a jig, and may use a positioning device for moving the jig and adjusting a position thereof, to adjust and align the positions of the wings with a target position. Conventionally, as the jig and the positioning device are connected by a simple support structure using a ball and a ball socket, problems of separation or misalignment may occur.

### SUMMARY

The following summary presents a simplified summary of certain features. The summary is not an extensive overview and is not intended to identify key or critical elements.

Systems, apparatuses, and methods are described for an aircraft assembly system. An aircraft assembly system may comprise a jig and a position adjuster configured to connect to the jig and to adjust a position of the jig. The jig may comprise a ball stud. the position adjuster may comprise a socket configured to accommodate at least a portion of the ball stud such that the ball stud is rotatably fastened. The socket may comprise a clamping unit configured to clamp the ball stud. Also, or alternatively, a ball stud support device may comprise a rod having a predetermined length in a first direction and a socket disposed at an end portion of the rod, configured to receive at least a portion of a ball stud, and configured to rotatably fasten the ball stud therein, the socket may comprise: a socket housing connected to the rod and a clamping unit disposed in the socket housing and configured to clamp or unclamp the ball stud accommodated therein. The clamping unit may comprise a ball configured to clamp or unclamp the ball stud to the socket as the ball is in contact with or moves away from the ball stud.

These and other features and advantages are described in greater detail below.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 illustrates an aircraft assembly system according to an example of the present disclosure.

FIG. 2 illustrates a position adjuster and a jig of an aircraft assembly system according to an example of the present disclosure, and an aircraft.

FIG. 3 illustrates a state in which a jig of an aircraft assembly system according to an example of the present disclosure is coupled to a wing of an aircraft.

FIG. 4 illustrates a jig and a position adjuster of an aircraft assembly system according to an example of the present disclosure.

FIG. 5 illustrates a state in which a ball stud of a jig is connected to a socket of a position adjuster, according to an example of the present disclosure.

FIG. 6 illustrates a clamp fastening structure between a ball stud of a jig and a socket of a position adjuster, as illustrated in FIG. 5.

### DETAILED DESCRIPTION

The present disclosure may encompass various examples and variations. Specific examples are illustrated in the drawings and described in detail herein, but, this does not limit the present disclosure to the specific examples. The present disclosure should be understood to include all modifications, equivalents and substitutes included in the spirit and scope of the present disclosure.

Terms such as first, second, etc. may be used to describe various elements, but the elements should not be limited by the terms. The above terms may be used only for distinguishing one component from another. For example, without departing from the scope of the present disclosure, a first component may be referred to as a second component, and similarly, a second component may also be referred to as a first component. The term “and/or” may include a combination of a plurality of related listed items or any of a plurality of related listed items.

The terms used in the present application may be only used to describe specific examples, and may not be intended to limit the present disclosure. The singular expression may include the plural expression unless the context clearly dictates otherwise. In the present application, terms such as “comprise” or “have” may be intended to designate that a feature, number, step, operation, component, part, or combination thereof described in the specification exists, but one or more other features. It should be understood that this does not preclude the existence or addition of numbers, steps, operations, components, parts, or combinations thereof.

Unless defined otherwise, all terms used herein, including technical or scientific terms, include the same meaning as commonly understood by one of ordinary skill in the art to which the present disclosure belongs. Terms such as those defined in a commonly used dictionary should be interpreted as having a meaning consistent with the meaning in the context of the related art, and should not be interpreted in an ideal or excessively formal meaning unless explicitly defined in the present application.

In this specification, an aircraft may mean a mobility vehicle that may move by flying in the sky. That is, in addition to referring to a helicopter, a drone, a tilt rotor, a fixed-wing airplane, or the like, the aircraft may also include a vehicle that may move on the ground using wheels and the like and may also fly (e.g., with the wheels separated from the ground). Additionally, the aircraft may include a manned aircraft or an unmanned aircraft. The manned aircraft may include an aircraft that may operate autonomously, in addition or alternative to an aircraft controlled by a pilot.

Hereinafter, examples of the present disclosure will be described with reference to the drawings.

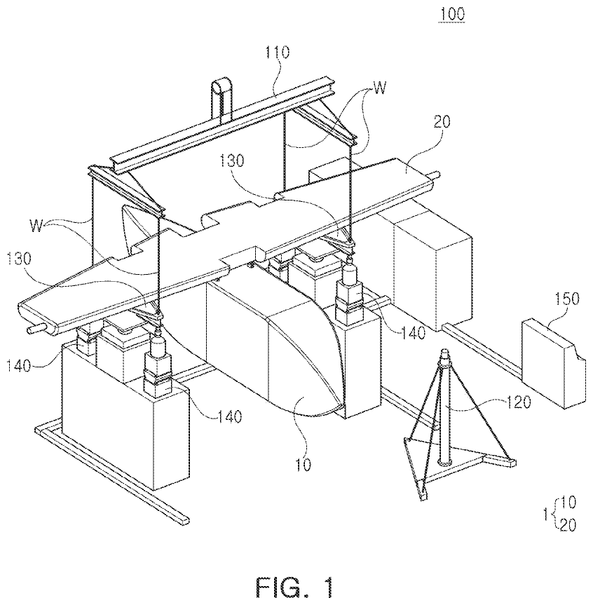

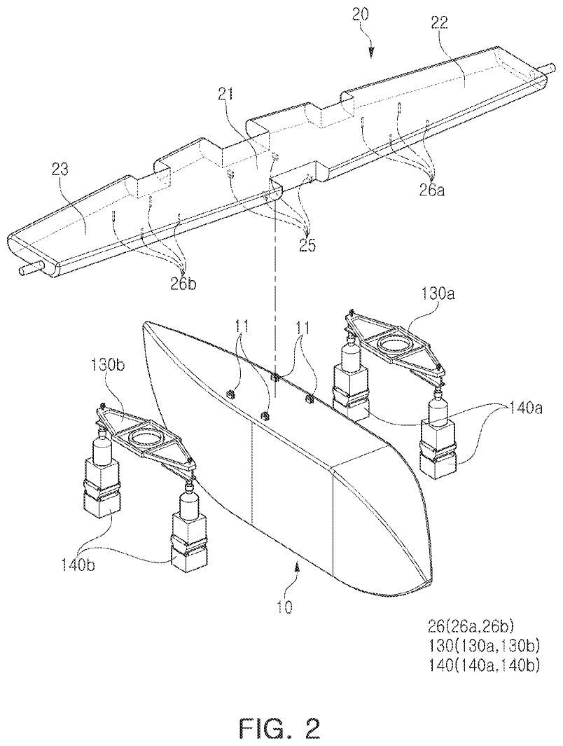

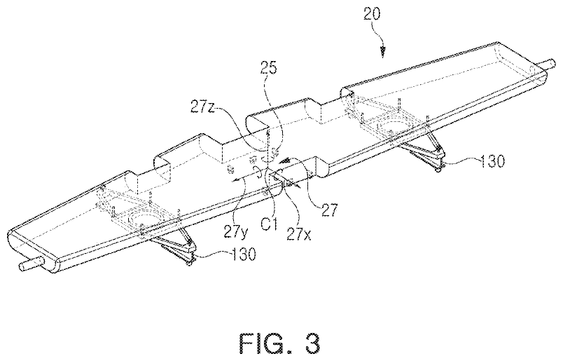

FIG. 1 illustrates an aircraft assembly system 100 according to an example of the present disclosure. FIG. 2 illustrates a position adjuster 140 and a jig 130 of an aircraft assembly system 100 according to an example of the present disclosure, and an aircraft 1. FIG. 3 illustrates a state in which a jig 130 of an aircraft assembly system 100 according to an example of the present disclosure is coupled to a wing 20 of an aircraft 1.

FIG. 1 schematically illustrates an overall configuration of an aircraft assembly system 100. FIG. 2 is a view in which a transfer unit 110, a measurement unit 120, and a controller 150 are omitted from the aircraft assembly system 100 of FIG. 1, and illustrates a wing 20 and a jig 130 in a separated state. FIG. 3 illustrates a state in which a jig 130 of an aircraft assembly system 100 is coupled to a wing 20 of an aircraft 1.

Referring to FIGS. 1 to 3, an aircraft assembly system (e.g., for an aircraft assembly facility) 100 according to an example may be an assembly system or an assembly facility for assembling an aircraft 1 including a fuselage 10 and a wing 20. For example, the aircraft assembly system 100 may be configured to align the wing 20 to a coupling position on the fuselage 10 by adjusting transfer and a position of the wing 20 with respect to the fuselage 10, which is relatively fixed, and then assemble the fuselage 10 and the wing 20.

The fuselage 10 may include a wing coupling portion 11 to which the wing 20 may be coupled. The wing coupling portion 11 may be formed in/on an portion of the fuselage 10 configured to face the wing 20 (e.g., in/on an upper portion and/or surface of the fuselage 10). The wing coupling portion 11 may be provided as a plurality of wing coupling portions 11. For example, the plurality of wing coupling portions 11 may be constructed using a plurality of clevis, but the present disclosure is not limited thereto.

The wing 20 may include a central portion 21, a first (e.g., right) wing portion 22 extending from a first (e.g. right) side of the central portion 21, and a second (e.g., opposite to the first, e.g., left) wing portion 23 extending from a second (e.g., opposite to the first, e.g., left) side of the central portion 21. The central portion 21 may be coupled to the fuselage 10, and the wing portions 22 and 23 may be coupled to a jig 130.

The wing 20 may include a fuselage coupling portion 25 to which the fuselage 10 may be coupled. The fuselage coupling portion 25 may be formed in the central portion 21 of the wing 20. For example, the fuselage coupling portion 25 may be formed in/on a portion of the central portion 21 configured to face the wing coupling portion 11 (e.g., a lower portion/lower surface of the central portion 21). The fuselage coupling portion 25 may be provided as a plurality of fuselage coupling portions 25 such that a plurality of wing coupling portions 11 are coupled to the plurality of fuselage coupling portions 25. For example, the plurality of fuselage coupling portions 25 may be constructed using a plurality of lugs, but the present disclosure is not limited thereto. The plurality of fuselage coupling portions 25 may be formed in a number and shape, corresponding to the plurality of wing coupling portions 11, and the wing 20 and the fuselage 10 may be coupled, as the plurality of wing coupling portions 11 and the plurality of fuselage coupling portions 25 are fastened to each other by a pin.

The wing 20 may include a jig coupling portion 26 to which the jig 130 is coupled. The jig coupling portion 26 may be formed on the wing portions 22 and 23 of the wing 20. For example, the jig coupling portion 26 may include a first jig coupling portion 26a formed on the first wing portion 22, and a second jig coupling portion 26b formed on the second wing portion 23. The first jig coupling portion 26a and the second jig coupling portion 26b may be symmetrical with respect to the central portion 21 of the wing 20. The jig 130 may be coupled to the jig coupling portion 26 during an assembly process of the wing 20 and the fuselage 10, and the jig 130 may be separated from the jig coupling portion 26 when assembly of the wing 20 and the fuselage 10 is completed.

An aircraft assembly system 100, according to an example, may include a transfer unit 110, a measurement unit 120, a jig 130, a position adjuster 140, and a controller 150.

The transfer unit 110 may transfer the wing 20 to the upper portion of the fuselage 10. For example, the transfer unit 110 may be connected to the jig 130, coupled to the wing 20, via a wire W, and the jig 130 may be towed to transfer the wing 20. Additionally, the transfer unit 110 may move the jig 130 to a position in which the jig 130 is connected to the position adjuster 140. For example, the transfer unit 110 may be seated or mounted on the position adjuster 140 by moving the jig 130. The transfer unit 110 may include, but is not limited to, a crane.

The measurement unit 120 may measure and track a position of the fuselage 10 and a position of the wing 20. The measurement unit 120 may sense the position of the fuselage 10 and the position of the wing 20, and may transmit a signal of the sensed position to the controller 150. The measurement unit 120 may include, for example, a laser tracker, and the laser tracker may direct a laser to a plurality of points on the fuselage 10 and the wing 20, to sense the position of the fuselage 10 and the position of the wing 20. The measurement unit 120 may be arranged to face a front surface of the fuselage 10, but a position of the measurement unit 120 is not limited to an illustrated example.

The measurement unit 120 may create and/or set a coordinate system for each of the fuselage 10 and the wing 20. For example, the measurement unit 120 may measure a center of the wing coupling portion 11 of the fuselage 10, and may create a coordinate system of the fuselage 10 centered at the center of the wing coupling portion 11. Additionally, or alternatively, the measurement unit 120 may measure a center of the fuselage coupling portion 25 of the wing 20, and may create a coordinate system of the wing 20 centered at the center of the fuselage coupling portion 25. An aircraft assembly system 100 according to an example of the present disclosure may be configured to set each of the coordinate systems for the wing 20 and the fuselage 10 by the measurement unit 120, and assemble the fuselage 10 and the wing 20 by aligning the coordinate system of the wing 20 and the coordinate system of the fuselage 10 to coincide with each other by moving the wing 20 using the coordinate system of the fuselage 10 as a fixed coordinate system (and/or an absolute coordinate system).

The jig 130 may be coupled to the wing 20 to be movable together with the wing 20. The jig 130 may be connected to the transfer unit 110 and the position adjuster 140, respectively, and may move by an operation (e.g., driving) of the transfer unit 110 and/or the position adjuster 140. For example, the wing 20 may be connected to the transfer unit 110 and the position adjuster 140 via the jig 130, thereby moving the jig 130 may move the wing 20 to and align with an assembly position on the fuselage 10. The jig 130 may be connected to the transfer unit 110 via the wire W, and may be transferred to the upper portion of the fuselage 10 together with the wing 20 by the transfer unit 110. The jig 130 may be transferred to a position in which the jig 130 is connected to the position adjuster 140 by the transfer unit 110, and may be connected to the position adjuster 140 in a state in which the wing 20 is located on the upper portion of the fuselage 10. A position of the jig 130 may be adjusted by the position adjuster 140 such that the fuselage coupling portion 25 of the wing 20 is aligned with the wing coupling portion 11 of the fuselage 10.

The jig 130 may include a first jig 130a and a second jig 130b, coupled to both sides of the wing 20. For example, the first jig 130a may be coupled to the first jig coupling portion 26a of the first wing portion 22, and the second jig 130b may be coupled to the second jig 26a of the second wing portion 23. The first jig 130a and the second jig 130b may have the same shape or structure.

The position adjuster 140 may be connected to the jig 130, and may adjust the position of the jig 130. The position adjuster 140 may adjust the position of the jig 130 by moving the jig 130. The wing 20 may be accurately aligned at the assembly position on the fuselage 10 by an operation in which the position of the jig 130 is adjusted by the position adjuster 140. For example, the position adjuster 140 may adjust the position of the jig 130 such that the coordinate system of the wing 20 set by the measurement unit 120 matches the coordinate system of the fuselage 10.

The position adjuster 140 may be detachably connected/connectable to the jig 130. When assembly of the wing 20 and the fuselage 10 is completed, the position adjuster 140 and the jig 130 may be disconnected and/or separated. For example, the position adjuster 140 may be clamp-coupled/couplable to a portion of the jig 130.

The position adjuster 140 may support both end portions of the jig 130. For example, the position adjuster 140 may include a pair of first position adjusters 140a connected to both ends of the first jig 130a, and a pair of second position adjusters 140b connected to both ends of the second jig 130b. The four position adjusters constituting the pair of first position adjusters 140a and the pair of second position adjusters 140b may be driven independently. The number of position adjusters 140 is not limited to the illustrated example discussed herein.

The pair of first position adjusters 140a and the pair of second position adjusters 140b may move a portion of the jig 130 connected to each thereof in one, two and/or three axial directions. For example, the portion of the jig 130 connected to the position adjuster 140 may move linearly in three axial directions by driving the position adjuster 140.

A coordinate system 27 having a center Cl positioned at a center of the plurality of fuselage coupling portions 25 as a reference points may be set and/or created on the wing 20. The coordinate system 27 of the wing may include an X-axis, a Y-axis, and a Z-axis, each perpendicular to each other. The wing 20 may move in six directions, based on a coordinate system 40, by an operation of moving a portion of the jig 130 connected to each of the pair of first position adjusters 140a and the pair of second position adjusters 140b in three axial directions. For example, as the first jig 130a and the second jig 130b move by four position adjusters 140, the wing 20 may perform linear movement (e.g., translational movement) in an X-axis (27x) direction, a Y-axis (27y) direction, and/or a Z-axis (27z) direction, and/or may perform rotational movement around an X-axis (27x), a Y-axis (27y), and a Z-axis (27z), respectively. The rotational movement of the wing 20 may include rolling, in which the wing 20 rotates around the X-axis (27x), pitching, in which the wing 20 rotates around the Y-axis (27y), and/or yawing, in which the wing 20 rotates about the Z-axis (27z).

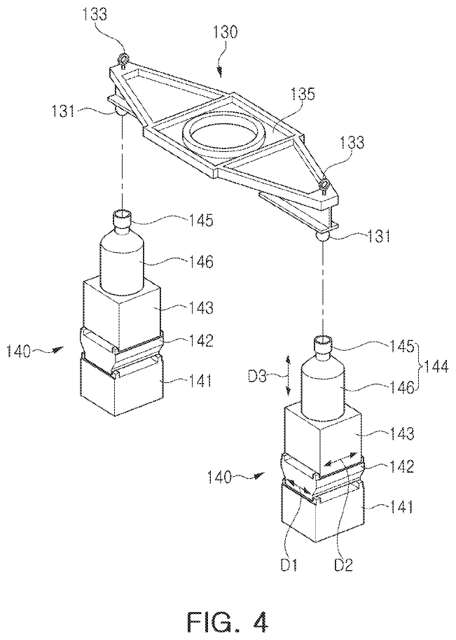

A structure of the position adjuster 140 and a connection structure of the position adjuster 140 and the jig 130 for implementing the linear movement in three axial directions will be described in detail below with reference to FIGS. 4 to 6.

The controller 150 may control driving of the transfer unit 110 and driving of the position adjuster 140. The controller 150 may receive a position signal transmitted from the measurement unit 120, and may generate displacement data for a position difference between a fixed coordinate system 30 set on the fuselage 10 and a moving coordinate system 40 set on the wing 20. The controller 150 may generate movement path data of the wing 20 for aligning, based on the displacement data, the moving coordinate system with the fixed coordinate system. The controller 150 may generate driving data of the position adjuster 140, based on the movement path data, and may transmit the driving data to the position adjuster 140, to control the driving of the position adjuster 140.

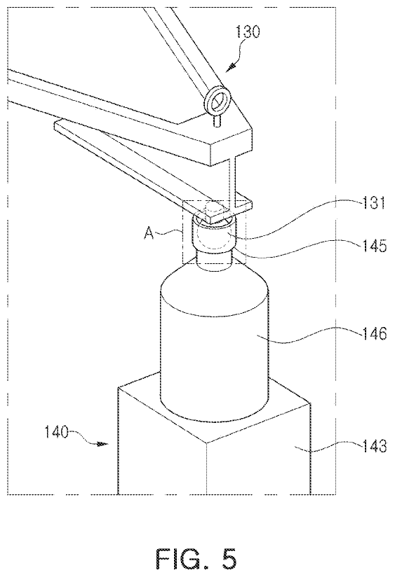

FIG. 4 illustrates a jig 130 and a position adjuster 140 of an aircraft assembly system 100 according to an example of the present disclosure. FIG. 5 illustrates a state in which a ball stud 131 of a jig 130 is connected to a socket 145 of a position adjuster 140, according to an example of the present disclosure.

FIG. 4 illustrates only a jig 130 and a pair of position adjusters 140 supporting the same, but the contents described below may be equally applied to a first jig 130a, a second jig 130b, a pair of first position adjusters 140a, and a pair of second position adjusters 140b.

Referring to FIGS. 4 and 5, a jig 130 and a position adjuster 140 of an aircraft assembly system 100 according to an example may be connected (e.g., fastened) using a ball joint manner.

The jig 130 may be rotatably and detachably coupled to the position adjuster 140 using a ball joint structure. The jig 130 may include a ball stud 131 that may be fastened to the position adjuster 140 with a ball joint socket 145. While the figures and examples herein describe the jig 130 including the ball stud 131 fastenable to a ball joint socket 145 of the position adjuster, one skilled in the art will understand that also, or alternatively, the jig 130 may comprise the ball joint socket 145 and the position adjuster may comprise the ball stud 131 for rotatably and detachably coupling the jig 130 to the position adjuster. Ball studs 131 may be formed in both end portions of the jig 130, and may be formed on a lower surface of the jig 130 so as to face the position adjuster 140 (e.g., a socket 145).

The jig 130 may include a wire connection portion 133 to which a wire W of a transfer portion 110 is connected. For example, the wire W may be bound to the wire connection portion 133, and the jig 130 may be connected to the transfer unit 110 through the wire W, as the wire connection portion 133 and the wire W are bound to each other. The wire connection portion 133 may be constructed using an eyebolt, but is not limited thereto.

The jig 130 may include a plate 135 forming a main exterior of the jig 130. The wire connection portion 133 may be formed on both end portions of an upper surface of the plate 135, and the ball studs 131 may be formed on both end portions of a lower surface of the plate 135. In this case, the upper surface of the plate 135 may be a surface to which the wing 20 is coupled, and the lower surface of the plate 135 may be a surface opposite to the upper surface, and may face a ground. This orientation is illustrative, and one skilled in the art would understand that the directions discussed could be adjusted to be with respect to another reference than the ground.

The position adjuster 140 may be configured to move the portion connected to the jig 130 in three axial directions, perpendicular to each other. For example, a portion of the position adjuster 140 to which the jig 130 is connected may perform linear movement in three axis (e.g., a first axis D1, a second axis D2, and a third axis D3) directions, perpendicular to each other.

The position adjuster 140 may include a base unit 141, a first sliding portion 142 movably (e.g., slidingly) coupled to the base unit 141 in the first axial D1 direction, a second sliding portion 143 movably coupled to the first sliding portion 142 in the second axial D2 direction, perpendicular to the first axis D1, and a third sliding portion 144 movably coupled to the second sliding portion 143 in the third axial D3 direction, perpendicular to the first axis D1 and the second axis D2. The third sliding portion 144 may be drawn into an internal space of the second sliding portion 143 (e.g., slide in) or pulled out from the internal space of the second sliding portion 143 (e.g., slide out). In this case, referring to FIG. 3 together, the first axis D1 may be parallel to an X-axis 27x of a wing coordinate system 27, the second axis D2 may be parallel to a Y-axis of the wing coordinate system 27, and the third axis D3 may be parallel to a Z-axis of the wing coordinate system 27. A relationship between the first to third axes D1, D2, and D3 and the wing coordinate system 27 is not limited to the above-described example, and may be changed, depending on a direction and a position in which the position adjuster 140 is disposed.

The base portion 141 may be supported against or fixed to the ground. When the first sliding portion 142 moves in the first axial D1 direction based on the base portion 141, the third sliding portion 144 and the second sliding portion 143 may move together with the first sliding portion 142. When the second sliding portion 143 moves in the second axial D2 direction based on the first sliding portion 142, the base portion 141 and the first sliding portion 142 may be relatively fixed, and the third sliding portion 144 may move together with the second sliding portion 143. When the third sliding portion 144 moves in the third axial D3 direction based on the second sliding portion 143, the base portion 141, the first sliding portion 142, and the second sliding portion 143 may be relatively fixed, and only the third sliding portion 144 may move. Although not illustrated, the position adjuster 140 may include a driver (a motor or an actuator) providing driving force to move the first sliding portion 142, the second sliding portion 143, and the third sliding portion 144.

The third sliding portion 144 may include a socket 145 to which the ball stud 131 of the jig 130 is coupled in a ball joint manner. For example, the ball stud 131 and the socket 145 may form a ball joint structure. The socket 145 may be formed in an upper end portion of the third sliding portion 144. For example, the third sliding portion 144 may include a rod 146 extending (e.g., perpendicularly) towards the second sliding portion 143, and the socket 145 may be disposed in an upper end portion of the rod 146. The upper end portion of the rod 146 refers to a portion opposite to a lower end portion of the rod 146 to which the second sliding portion 143 is connected. The rod 146 may extend in the third axial D3 direction, and may have a predetermined length. For example, the rod 146 may be formed in a cylindrical shape extending with a height/length in the third axial D3 direction, but is not limited thereto. In addition, according to an illustrated example, the rod 146 may be formed to have a shape in which a cross-section of a portion connected to the socket 145 becomes narrower in the D3 direction away from the second sliding portion 143 (e.g., an upward direction), but this is merely illustrative, and the shape of the rod 146 is not limited to that of an illustrated example.

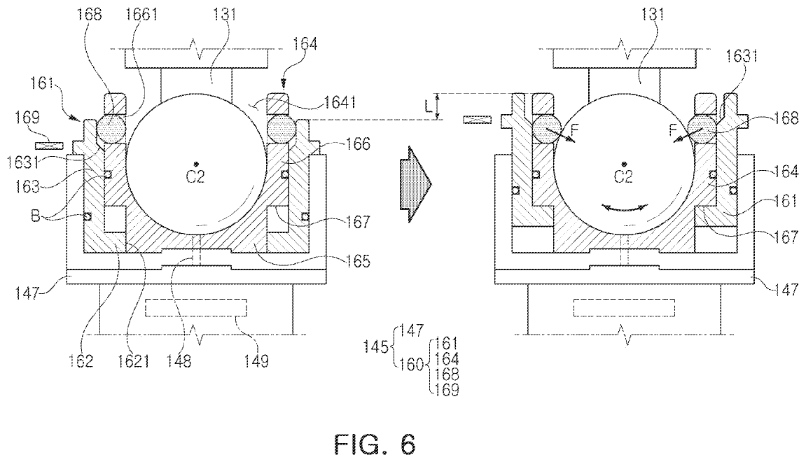

The socket 145 may be rotatably coupled to the ball stud 131. At least a portion of the ball stud 131 may be accommodated in an internal space of the socket 145, and the ball stud 131 may rotate relative to the socket 145 while accommodated in the internal space of the socket 145. For example, the ball stud 131 may rotate 360 degrees within the socket 145 based on a center point of the ball stud 131. The socket 145 may include a clamp structure for supporting and clamping the ball stud 131. The clamp structure provided in the socket 145 will be described in detail with reference to FIG. 6 below.

Referring to FIG. 3 together, the aircraft assembly system 100 according to an example may control and drive independently four position adjusters 140 including a pair of first position adjusters 140a and a pair of second position adjusters 140b. Therefore, a six-degree-of-freedom (6DOF) control system an operation of linearly moving the wing 20 in each of the three axes (e.g., determining the position) and an operation of rotating the wing 20 around each of the three axes (e.g., determining the orientation) are possible may be implemented.

FIG. 6 illustrates a clamp fastening structure between a ball stud 131 of a jig 130 and a socket 145 of a position adjuster 140, as illustrated in FIG. 5.

FIG. 6 may be an enlarged cross-sectional view of portion A of FIG. 5. FIG. 6 illustrates a process of performing a clamping operation using a ball 168. For example, a left picture of FIG. 6 illustrates a state before clamping, and the right picture of FIG. 6 illustrates a state after clamping.

Referring to FIG. 6, a position adjuster 140 of an aircraft assembly system 100, according to an example, may be provided with a clamp structure (e.g., a clamping unit 160, or a clamp) for clamping a ball stud 131 of a jig 130. For example, the clamp structure 160 may be provided in a socket 145, and may support and clamp the ball stud 131 using a ball 168 for clamping. The position adjuster 140 may also be referred to as a ball stud support device or a ball stud clamp device.

The socket 145 may include a socket housing 147 and a clamping unit 160 at least partially disposed in an internal space of the socket housing 147.

The socket housing 147 may form at least a portion of an exterior of the socket 145. The socket housing 147 may be connected to a rod 146. For example, the socket housing 147 may extend from an upper end portion of the rod 146. At least a portion of the clamping unit 160 may be accommodated in the internal space of the socket housing 147. The socket housing 147 may support the clamping unit 160, and may be connected to at least a portion of the clamping unit 160.

A nozzle 148 spraying air at a predetermined pressure may be disposed in the internal space of the socket housing 147. The nozzle 148 may be built into the socket housing 147. For example, the nozzle 148 may be an air blowing nozzle embedded in the internal space of the socket housing 147 to spray air. Arrangement of the nozzle 148 is not limited to the above-described example.

The nozzle 148 may be configured to spray air into a space 1641 in which the ball stud 131 in an internal space of a ball bracket 164 is accommodated. For example, the nozzle 148 may spray air into the accommodation space 1641 of the ball stud 131 to remove a foreign substance from an internal space of the accommodation space 1641. The nozzle 148 may be built into the socket housing 147, and may extend to penetrate the ball bracket 164. For example, the nozzle 148 (e.g., an air outlet of the nozzle 148) may be exposed on an internal wall of the ball bracket 164 forming the accommodation space 1641 of the ball stud 131 to be connected to the accommodation space 1641, to spray air in an internal space of the accommodation space 1641.

A load sensor 149 measuring a load applied to the socket 145 may be disposed in an internal space of the socket housing 147. The load sensor 149 may be configured using various sensors measuring force or weight. For example, the load sensor 149 may include, but is not limited to, a load cell.

The load sensor 149 may measure the load applied to the socket 145 to determine whether the ball stud 131 is seated or mounted on the socket 145 (e.g., the ball bracket 164 of the clamping unit 160), and whether the load is excessively concentrated on the socket 145 of a specific position adjuster 140 among the plurality of position adjusters 140. The load sensor 149 may transmit measured load information to a controller of the position adjuster 140 (e.g., a controller 150 of the aircraft assembly system 100 of FIG. 1). For example, the controller may determine, based on transmitted load information, whether the ball stud 131 is normally seated and/or whether the load is concentrated on a specific socket 145.

The load information measured by the load sensor 149 may be used to sense and/or determine whether the ball stud 131 is normally seated (e.g., as compared to a minimum load applied to the socket 145) in a state in which the ball stud 131 is normally seated in the socket 145. For example, when a load measured by the load sensor 149 is equal to or greater than the minimum load, it may be determined that the ball stud 131 is normally seated. In this case, the minimum load may be a predetermined value.

In addition, the load information measured by the load sensor 149 may be used to sense or determine whether the load is excessively concentrated on a specific socket 145, as compared to an abnormal load abnormally applied to the specific socket 145, when the jig 130 deviates from a transfer path. For example, when a load measured by the load sensor 149 is equal to or greater than the abnormal load, it may be determined that the load is excessively concentrated on the specific socket 145. In this case, the abnormal load may be a predetermined value.

According to an illustrated example, the load sensor 149 may be disposed in the internal space of the socket housing 147, but a location in which the load sensor 149 is disposed is not limited thereto. According to various examples, the load sensor 149 may be disposed in various portions of the socket 145 within a range in which a function of measuring the load applied to the socket 145 may be performed. For example, the load sensor 149 may be disposed in a portion of the clamping unit 160 (e.g., a guide member 161 or a ball bracket 164) when measurement of a load applied to the socket 145 is possible.

The clamping unit 160 may be disposed in the internal space of the socket housing 147. At least a portion of the clamping unit 160 may be connected to the socket housing 147 to be supported by the socket housing 147. For example, a portion of the clamping unit 160 (e.g., the ball bracket 164) may be fixedly connected/coupled to the socket housing 147, and a different portion of the clamping unit 160 (e.g., the guide member 161) may be movably connected/coupled to the socket housing 147.

According to an example illustrated in FIG. 6, a portion of the clamping unit 160 may be exposed outside the socket housing 147. For example, a portion of the clamping unit 160 (e.g., a portion of the guide member 161 and a portion of the ball bracket 164) may not be surrounded by the socket housing 147, and may be located outside the socket housing 147. This is illustrative, and a shape of the socket 145 is not limited to an illustrated example. According to various examples, the socket housing 147 may be configured to entirely accommodate the clamping unit 160 therein such that the clamping unit 160 is not exposed externally when looking at an external side surface of the socket 145. For example, an external side wall of the socket housing 147 may extend high to entirely surround the clamping unit 160.

The clamping unit 160 may include a guide member 161, a ball bracket 164, a ball 168, and a clamp confirmation sensor 169. For example, the clamping unit 160 may be referred to as a ball clamping unit or a ball clamp device.

The guide member 161 may be disposed in the internal space of the socket housing 147, to be movable in a vertical direction with respect to the socket housing 147. For example, the guide member 161 may be connected to the internal space of the socket housing 147, to be movable in a vertical direction (e.g., in the third axial D3 direction in FIG. 4). In this case, the vertical direction refers to the third axial D3 direction, which may be a direction in which a rod 146 (and/or a third sliding portion 144) slides with respect to a second sliding portion 143. The guide member 161 may perform a clamping operation through the ball 168 by moving, based on the socket housing 147 and the ball bracket 164, the ball 168 while moving linearly in a vertical direction. Although not illustrated, the position adjuster 140 may include a driver (a motor and/or an actuator) providing driving force for movement of the guide member 161.

The guide member 161 may include a bottom portion 162 and a side wall portion 163 extending vertically from an edge of the bottom portion 162. An opening 1621 in which the ball bracket 164 is located may be formed in the bottom portion 162 such that the ball bracket 164 and the socket housing 147 are connected. An inclined surface (and/or tapered surface) 1631 guiding movement of the ball 168 may be formed on the side wall portion 163. The inclined surface 1631 may be formed in a shape that slopes (e.g., downward) toward an internal space of the guide member 161. For example, the inclined surface 1631 may be inclined downward toward the ball bracket 164 disposed in the internal space of the guide member 161. When the guide member 161 moves in a vertical direction, the ball 168 may move along the inclined surface 1631, and may be in contact with or be spaced apart from the ball stud 131.

The bottom portion 162 of the guide member 161 may be in contact with a bottom surface of the socket housing 147 or be spaced apart from a bottom surface of the socket housing 147 by a first length L, as the guide member 161 moves in a vertical direction with respect to the socket housing 147.

The side wall portion 163 of the guide member 161 may be in contact with a side wall of the socket housing 147. The side wall portion 163 may be configured to move relative to the side wall of the socket housing 147. For example, a ball bearing B may be disposed between the side wall portion 163 and the side wall of the socket housing 147 to enable relative movement of the side wall portion 163 and the side wall of the socket housing 147.

The ball bracket 164 may be disposed in an internal space of the guide member 161. The ball 168 for clamping may be disposed on the ball bracket 164. The ball bracket 164 may be disposed in the internal space of the guide member 161, and may be fixedly coupled to the socket housing 147. For example, the ball bracket 164 may be connected to the socket housing 147 through an opening 1621 formed in the bottom portion 162 of the guide member 161. A predetermined accommodation space 1641 in which the ball stud 131 is accommodated may be formed in an internal space of the ball bracket 164.

The ball bracket 164 may include a coupling portion 165 coupled to the socket housing 147, and an extension portion 166 extending from the coupling portion 165. The accommodation space 1641 may be formed by the coupling portion 165 and the extension portion 166. For example, the ball stud 131 accommodated in the internal space of the ball bracket 164 may be surrounded by the coupling portion 165 and the extension portion 166. The coupling portion 165 and the extension portion 166 may be connected in a stepped manner. For example, a protrusion (and/or a stepped surface) 167 may be formed between the coupling portion 165 and the extension portion 166. The protrusion 167 may limit a vertical movement range of the guide member 161. For example, the guide member 161 may move in an upward direction within a range in which the bottom portion 162 is in contact with the protrusion 167, and may not be separated from the socket housing 147 by contacting the protrusion 167.

The coupling portion 165 of the ball bracket 164 may be disposed in an internal space of the opening 1621 of the guide member 161, to contact the bottom surface of the socket housing 147. The coupling portion 165 may be fixedly coupled to the socket housing 147. For example, the coupling portion 165 and the socket housing 147 may be coupled by various coupling methods (e.g., screw coupling, bonding, adhesive, or the like).

The extension portion 166 of the ball bracket 164 may extend parallel to the side wall portion 163 of the guide member 161. The extension portion 166 may be in contact with the side wall portion 163. The extension portion 166 may be configured to be movable relative to the side wall portion 163. For example, the ball bearing B may be disposed between the extension portion 166 and the side wall portion 163 to enable relative movement thereof.

The extension portion 166 of the ball bracket 164 may movably support the ball 168. A coupling groove 1661 to which the ball 168 is movably coupled may be formed in the extension portion 166 of the ball bracket 164. For example, the coupling groove 1661 may be formed to accommodate the ball 168 to move without being separated from an internal space of the coupling groove 1661. The coupling groove 1661 may be formed to be located above the inclined surface 1631 in a state before clamping. The coupling groove 1661 may be formed such that the ball 168 may move in a direction (e.g., left or right direction), perpendicular to a moving direction (e.g., upward or downward direction) of the guide member 161. A shape of the coupling groove 1661 is not limited thereto. For example, the coupling groove 1661 may be formed to allow the ball 168 to move in a direction in which the inclined surface 1631 is inclined.

The ball 168 may be movably coupled to the ball bracket 164. For example, the ball 168 may be movably coupled into an internal space of the coupling groove 1661 formed in the extension portion 166 of the ball bracket 164. The ball 168 may move along the inclined surface 1631 of the guide member 161 based on movement of the guide member 161 in a vertical direction with respect to the ball bracket 164, thereby contacting or separating from the ball stud 131. The ball 168 may perform a clamping operation on the ball stud 131 as the ball 168 is in contact with or is spaced apart from the ball stud 131.

In a state before clamping (e.g., a state illustrated in the left figure of FIG. 6), when the guide member 161 moves upward relative to the ball bracket 164 and the socket housing 147 by a first length L, the ball 168 may move toward the ball stud 131 along the inclined surface 1631 of the guide member 161 and may be in contact with the ball stud 131 to apply an external force F. By pressing the ball against the ball stud 131 (F), the ball stud 131 (e.g., the jig 130) and the socket 145 (e.g., the position adjuster 140) may be clamped to be in a state after clamping (e.g., a state illustrated in the right picture of FIG. 6). In the state after clamping, the bottom portion 162 of the guide member 161 may be spaced apart from the bottom surface of the socket housing 147 by the first length L, and may be in contact with the extension portion 166 of the ball bracket 164 (e.g., the protrusion 167).

In the state after clamping, when the guide member 161 moves downward with respect to the ball bracket 164 and the socket housing 147 by the first length L, the ball 168 may move along the inclined surface 1631 of the guide member 161 in a direction away from the ball stud 131, and may be separated from the ball stud 131, to remove the external force F applied to the ball stud 131. By releasing pressing (F) of the ball 168 against the ball stud 131, fastening of the ball stud 131 (e.g., the jig 130) and the socket 145 (e.g., the position adjuster 140) may be released, and the state after clamping (e.g., an unclamped state) may be returned. In the state after clamping, the bottom portion 162 of the guide member 161 may be spaced apart from the protrusion 167 by the first length L, and may be in contact with the bottom surface of the socket housing 147.

The clamp confirmation sensor 169 may check or detect whether clamp fastening is performed by the ball 168. For example, the clamp confirmation sensor 169 may measure or sense a position of the ball 168, and may check whether clamp fastening is performed based thereon. The clamp confirmation sensor 169 may be disposed in the socket 145 to sense the position of the ball 168. For example, the clamp confirmation sensor 169 may be mounted on either the socket housing 147 or the guide member 161. A position of the clamp confirmation sensor 169 is not limited to a specific position, and may be disposed in various positions within a range that may check whether clamp fastening is performed by sensing the position of the ball 168.

The clamp confirmation sensor 169 may generate an electrical signal indicating whether clamp fastening is performed, and may transmit the same to a controller of the position adjuster 140 (and/or a controller 150 of the aircraft assembly system 100 in FIG. 1). For example, the clamp confirmation sensor 169 may generate a clamp fastening signal indicating that clamp fastening is performed or a clamp releasing signal indicating that the clamp is released, based on position information of the ball 168, and may transmit the signals to the controller. The clamp confirmation sensor 169 may determine whether the ball 168 and the ball stud 131 are in contact based on the position information of the ball 168. The clamp confirmation sensor 169 may generate and transmit the clamp fastening signal when the ball 168 is in contact with the ball stud 131 and presses the ball stud 131, and may generate and transmit the clamp releasing signal when the ball 168 is spaced apart from the ball stud 131 and in a free state.

The position adjuster 140 may be driven based on the clamp fastening signal and the clamp releasing signal. For example, when the clamp fastening signal is transmitted, portions of the position adjuster 140 (e.g., the first sliding portion 142 to the third sliding portion 144) may be driven to move the jig 130 (alternatively, the wing 20 may move and aligned in a desired target position. Additionally, when the clamp releasing signal is transmitted, the jig 130 may move upward and separated from the position adjuster 140.

The clamp confirmation sensor 169 may be implemented using various types of sensors that may measure or sense the position of the ball 168. A method by which the clamp confirmation sensor 169 checks whether clamp fastening is performed is not limited to a method of measuring the position of the ball 168. The clamp confirmation sensor 169 may check whether clamp fastening is performed by determining whether the ball 168 and the ball stud 131 are in contact in various manners.

Hereinafter, with reference to FIGS. 1 and 2, an operation of driving a position adjuster 140 in an aircraft assembly system 100 according to an example will be described.

First, before a ball stud 131 may be mounted on a socket 145, a state in which a guide member 161 is lowered may be checked, and air may be sprayed through a nozzle 148 to remove a foreign substance from an internal space of the socket 145, especially an accommodation space 1641 of a ball bracket 164.

Next, a jig 130 may be transferred through a transfer portion 110, and the ball stud 131 of the jig 130 may be seated or mounted on the socket 145 of a position adjuster 140. For example, as illustrated in the left picture of FIG. 6, the ball stud 131 may be accommodated and seated in the accommodation space 1641 of the ball bracket 164. In this case, a load applied to the socket 145 may be measured by a load sensor 149, and whether the ball stud 131 is properly seated may be determined, as compared to a minimum load.

If a measured load is equal to or greater than the minimum load, it may be determined that the ball stud 131 is normally seated, and the guide member 161 may move upward to clamp the ball stud 131. For example, as illustrated in the right picture of FIG. 6, as the guide member 161 moves upward, the ball 168 may be in contact with and press the ball stud 131, and through this, the ball stud 131 may be clamped to the socket 145. In this case, whether clamp fastening is performed may be checked by the clamp confirmation sensor 169. In a state in which clamp fastening is performed, the ball stud 131 may rotate around a center of the ball stud 131 in the ball bracket 164.

In a state in which clamp fastening is performed, the position adjuster 140 may be driven to align the jig 130 and a wing 20 to a target position. For example, at least one of a first sliding portion 142, a second sliding portion 143, or a third sliding portion 144 of the position adjuster 140 may be driven based on a target position to be moved. Therefore, as the ball stud 131 rotates in the ball bracket 164, the jig 130 may move and be aligned to the target position. In this case, a load applied to the socket 145 may be measured by the load sensor 149, may be determined whether the load is excessively concentrated on a specific socket 145, among sockets 145 of four position adjusters 140, as compared to an abnormal load, and, based thereon, a point in which a transfer path deviates may be checked.

After aligning the wing 20 to the target position, the guide member 161 may move downward to release clamping of the ball stud 131. In this case, a state in which the clamping is released may be checked by the clamp confirmation sensor 169.

An aspect of the present disclosure is to provide an aircraft assembly system having a ball clamping unit in a position adjuster adjusting a position of a jig to which a wing is coupled, to stably support the jig and effectively adjust and align a position of the jig.

According to an aspect of the present disclosure, an aircraft assembly system includes a jig; and a position adjuster connected to the jig and adjusting a position of the jig, wherein the jig includes a ball stud provided between the jig and the position adjuster, and the position adjuster includes a socket in which at least a portion of the ball stud is accommodated and in which the ball stud is rotatably fastened.

The socket may include a clamping unit clamping the ball stud, wherein the clamping unit may include a ball configured to clamp or unclamp the ball stud to the socket as the ball is in contact with or moves away from the ball stud.

The socket may further include a socket housing in which at least a portion of the clamping unit is disposed, wherein the clamping unit may further include a guide member movably disposed in the socket housing and a ball bracket disposed in the guide member to movably support the ball.

The ball bracket may be fixedly coupled to the socket housing, wherein at least a portion of the guide member may be disposed between the ball bracket and the socket housing, and the guide member may be movable in a vertical direction with respect to the ball bracket and the socket housing.

The ball may be in contact with or move away from the ball stud, based on an operation of moving the guide member in a vertical direction with respect to the ball bracket and the socket housing.

The guide member may include a side wall portion connected in a vertical direction to surround at least a portion of an external side surface of the ball bracket, wherein an inclined surface guiding movement of the ball is formed on the side wall portion.

The inclined surface may be formed on an internal side surface of the side wall portion facing the ball bracket, and is formed to have a shape downwardly inclined in an inward direction.

The ball may move along the inclined surface of the guide member, based on an operation of moving the guide member with respect to the ball bracket and the socket housing, and a predetermined degree of pressing force may be applied to the ball stud if the ball is in contact with the ball stud.

The ball bracket may include a coupling portion coupled to a bottom surface of the socket housing, and an extension portion extending from the coupling portion and to which the ball may be movably coupled.

The guide member may further include a bottom portion disposed to face the bottom surface of the socket housing, wherein an opening in which the coupling portion is disposed is formed in the bottom portion, and wherein the coupling portion may pass through the opening and may be coupled to the bottom surface of the socket housing.

A protrusion may be formed between the coupling portion and the extension portion, wherein the guide member may be movable in an upward direction within a range in which the bottom portion is in contact with the protrusion.

The ball bracket may have an accommodation space in which the ball stud is accommodated, wherein the socket may further include a nozzle disposed on the socket housing and spraying air into the accommodation space.

The nozzle may be embedded in the socket housing and may extend through at least a portion of the ball bracket.

The socket may further include a load sensor disposed on the socket housing and measuring a load applied to the socket.

The clamping unit may further include a clamp confirmation sensor measuring a position of the ball and checking whether the clamping unit may be fastened, based on measured position information of the ball.

The position adjuster may include a base portion, a first sliding portion movably coupled to the base portion in a first axial direction, a second sliding portion movably coupled to the first sliding portion in a second axial direction, perpendicular to the first axial direction, and a third sliding portion movably coupled to the second sliding portion to be movable in a third axial direction, perpendicular to the first and second axial directions, wherein the socket may be provided on the third sliding portion.

The guide member may be movable in a direction, parallel to the third axial direction, with respect to the socket housing.

According to an aspect of the present disclosure, a ball stud support device includes a rod extending to have a predetermined length in one direction; and a socket disposed at an end portion of the rod, receiving at least a portion of a ball stud, and rotatably fastening the ball stud therein, wherein the socket includes a socket housing connected to the rod, and a clamping unit disposed in the socket housing and clamping the ball stud accommodated therein, wherein the clamping unit includes a ball configured to clamp or unclamp the ball stud to the socket as the ball is in contact with or moves away from the ball stud.

The clamping unit may further include a guide member movably disposed in the socket housing in a longitudinal direction of the rod and a ball bracket disposed inside the guide member to movably support the ball, wherein the ball bracket may be fixedly coupled to the socket housing, wherein the guide member may move the ball as the guide member moves in the longitudinal direction with respect to the ball bracket and the socket housing.

The guide member may include an inclined surface guiding movement of the ball, wherein the ball may move along the inclined surface of the guide member based on an operation of moving the guide member in the longitudinal direction with respect to the ball bracket and the socket housing, and a predetermined degree of pressing force may be configured to be applied to the ball stud if the ball is in contact with the ball stud.

Additionally, in examples of the present disclosure, some components may be deleted, and the components of each example may be combined with each other.

According to an example of the present disclosure, a ball clamping unit may be provided in a position adjuster to stably support a jig and effectively adjust and align a position of the jig.

In addition, according to an example of the present disclosure, a position adjuster may be stably driven by checking whether a clamp is fastened and a seated state of a ball stud by a clamp confirmation sensor and a load sensor provided in the position adjuster.

While example examples have been illustrated and described above, it will be apparent to those skilled in the art that modifications and variations could be made without departing from the scope of the present disclosure as defined by the appended claims.

What is claimed is:

1. An aircraft assembly system comprising:
a jig; and
a position adjuster configured to connect to the jig and configured to adjust a position of the jig,
wherein the jig comprises a ball stud,
wherein the position adjuster comprises a socket configured to accommodate at least a portion of the ball stud such that the ball stud is rotatably fastened, and
wherein the socket comprises a clamping unit configured to clamp the ball stud.

2. The aircraft assembly system of claim 1,
wherein the clamping unit comprises a ball configured to clamp the ball stud to the socket by contacting the ball stud or to unclamp the ball stud from the socket by moving away from the ball stud.

3. The aircraft assembly system of claim 2, wherein the socket further comprises a socket housing in which at least a portion of the clamping unit is disposed,
wherein the clamping unit further comprises a guide movably disposed in the socket housing and a ball bracket disposed in the guide so as to movably support the ball.

4. The aircraft assembly system of claim 3, wherein the ball bracket is fixedly coupled to the socket housing,
wherein at least a portion of the guide is disposed between the ball bracket and the socket housing, and the guide is movable in a vertical direction with respect to the ball bracket and the socket housing.

5. The aircraft assembly system of claim 4, wherein the ball is configured to contact or move away from the ball stud based on movement of the guide in a vertical direction with respect to the ball bracket and the socket housing.

6. The aircraft assembly system of claim 4, wherein the guide comprises a side wall extending in a vertical direction to surround at least a portion of an external side surface of the ball bracket,
wherein the side wall comprises an inclined surface configured to guide movement of the ball.

7. The aircraft assembly system of claim 6, wherein the inclined surface:
is formed on an internal side surface, of the side wall, facing the ball bracket, and
has a shape downwardly inclined in an inward direction.

8. The aircraft assembly system of claim 6, wherein the ball is configured to move along the inclined surface of the guide based on movement of the guide with respect to the ball bracket and the socket housing, and
wherein a predetermined degree of pressing force is applied to the ball stud by the ball when in contact with the ball stud.

9. The aircraft assembly system of claim 6, wherein the ball bracket comprises:
a coupling portion coupled to a bottom surface of the socket housing, and
an extension portion extending from the coupling portion and to which the ball is movably coupled.

10. The aircraft assembly system of claim 9, wherein the guide further comprises a bottom portion disposed to face the bottom surface of the socket housing,
wherein an opening in which the coupling portion is disposed is formed in the bottom portion, and
wherein the coupling portion passes through the opening and is coupled to the bottom surface of the socket housing.

11. The aircraft assembly system of claim 10, wherein a protrusion is between the coupling portion and the extension portion, and
wherein the guide is movable in an upward direction within a range in which the bottom portion is in contact with the protrusion.

12. The aircraft assembly system of claim 3, wherein the ball bracket forms an accommodation space in which the ball stud is accommodated, and
wherein the socket further comprises a nozzle disposed on the socket housing and configured to spray air into the accommodation space.

13. The aircraft assembly system of claim 12, wherein the nozzle is in the socket housing and extends through at least a portion of the ball bracket.

14. The aircraft assembly system of claim 3, wherein the socket further comprises a load sensor disposed on the socket housing and configured to measure a load applied to the socket.

15. The aircraft assembly system of claim 3, wherein the clamping unit further comprises a clamp confirmation sensor configured to measure a position of the ball and to check, based on the measured position of the ball, whether the clamping unit is clamping the ball stud to the socket.

16. The aircraft assembly system of claim 3, wherein the position adjuster comprises:
a base portion;
a first sliding portion movably, in a first axial direction, coupled to the base portion;
a second sliding portion movably, in a second axial direction perpendicular to the first axial direction, coupled to the first sliding portion; and
a third sliding portion movably, in a third axial direction perpendicular to the first axial direction and to the second axial direction, coupled to the second sliding portion, and
wherein the socket is provided on the third sliding portion.

17. The aircraft assembly system of claim 16, wherein the guide is movable in a direction, parallel to the third axial direction, with respect to the socket housing.

18. A ball stud support device comprising:
a rod having a predetermined length in a first direction; and
a socket disposed at an end portion of the rod, configured to receive at least a portion of a ball stud, and configured to rotatably fasten the ball stud therein,
wherein the socket comprises:
a socket housing connected to the rod, and
a clamping unit disposed in the socket housing and configured to clamp or unclamp the ball stud accommodated therein,
wherein the clamping unit comprises a ball configured to clamp or unclamp the ball stud to the socket as the ball is in contact with or moves away from the ball stud.

19. The ball stud support device of claim 18, wherein the clamping unit further comprises:
a guide movably disposed in the socket housing in a longitudinal direction of the rod, and
a ball bracket disposed inside the guide so as to movably support the ball,
wherein the ball bracket is fixedly coupled to the socket housing, and
wherein the guide is configured to move the ball by moving in the longitudinal direction with respect to the ball bracket and the socket housing.

20. The ball stud support device of claim 19, wherein the guide comprises an inclined surface configured to guide movement of the ball, and
wherein the ball is configured to move along the inclined surface of the guide based on movement of the guide in the longitudinal direction with respect to the ball bracket and the socket housing, and
wherein a predetermined degree of pressing force is configured to be applied to the ball stud by the ball when in contact with the ball stud.
